(19) United States
(12) Patent Application Publication
(10) Pub. No.: US 2012/0076577 A1
(43) Pub. Date: Mar. 29, 2012

(54) ATTACHMENT/DETACHMENT MECHANISM AND OPERATION TOOL SYSTEM

(75) Inventor: Masaru YANAGIHARA, Hachioji-shi (JP)

(73) Assignee: OLYMPUS CORPORATION, Tokyo (JP)

(21) Appl. No.: 13/052,435

(22) Filed: Mar. 21, 2011

(30) Foreign Application Priority Data
Sep. 28, 2010 (JP) 2010-217902

(51) Int. Cl. F16B 7/04

(52) U.S. Cl. 403/375

(57) ABSTRACT

According to one embodiment, an attachment/detachment mechanism detachably fixes an insertion member and an outer sheath member. The mechanism includes a removal preventing member and a rotation preventing member. The removal preventing member is configured to restrict movement of the insertion member inserted in the outer sheath member relative thereto in a removing direction. The rotation preventing member is configured to restrict movement of the insertion member inserted in the outer sheath member relative thereto in a rotating direction.

### CROSS-REFERENCE TO RELATED APPLICATIONS

This application is based upon and claims the benefit of priority from prior Japanese Patent Application No. 2010-217902, filed Sep. 28, 2010, the entire contents of which are incorporated herein by reference.

### BACKGROUND OF THE INVENTION

1. Field of the Invention

The present invention relates to an attachment/detachment mechanism for, for example, an operation tool used for surgical operation or the like, and an operation tool system.

2. Description of the Related Art

There is known an operation tool system which makes an operation tool having flexibility reach an operation field upon insertion of the tool into an outer sheath and allows to perform medical practice by operating (for example, pushing and pulling/rotating) the operation tool. In this operation tool system, operation tools and an outer sheath are configured to be detachable. The operation tools are interchanged in accordance with a surgical procedure. Obviously, the operation tools having flexibility are low in rigidity.

In this case, the operation tools include, for example, surgical operation tools and observation tools. Surgical operation tools are operation tools (for example, scalpels and scissors) for treating a tissue region inside the body of a patient. A manipulator in which a surgical operation tool is mounted is called a treatment manipulator. Observation tools are operation tools (for example, an electronic endoscope) for the observation of a tissue region inside the body of a patient. A manipulator in which an observation tool is mounted is called an observation manipulator.

As a technique associated with an attachment/detachment mechanism for an outer sheath and an insertion member, for example, the following technique is disclosed in Jpn. Pat. Appln. KOKAI Publication No. 9-131352. That is, Jpn. Pat. Appln. KOKAI Publication No. 9-131352 discloses an electrosurgery electrode connector which allows to attach/detach a disposable pointed member for electrosurgery to/from a nondisposable support member as a main body with one touch. More specifically, a pair of projections provided on the support member engage with holes provided in a connection member, thereby mounting/fixing the members to each other.

According to the attachment/detachment mechanism disclosed in Jpn. Pat. Appln. KOKAI Publication No. 9-131352, the pair of projections provided on the support member tilt in the twisting direction (rotating direction). This makes it possible to easily insert the projections provided on the support member into the holes provided in the connection member when mounting the support member on the connection member.

### BRIEF SUMMARY OF THE INVENTION

According to an aspect of the present invention, there is provided an attachment/detachment mechanism which detachably fixes an insertion member inserted in an outer sheath member thereto, the mechanism comprising:

a removal preventing member configured to restrict movement of the insertion member in the outer sheath member relative thereto in a removing direction; and

a rotation preventing member configured to restrict movement of the insertion member in the outer sheath member relative thereto in a rotating direction.

According to an aspect of the present invention, there is provided an operation tool system comprising an operation tool as an insertion member, and an outer sheath member in which the operation tool is inserted, the system comprising:

a removal preventing member configured to restrict movement of the operation tool inserted in the outer sheath member relative thereto in a removing direction; and

a rotation preventing member configured to restrict movement of the insertion member inserted in the outer sheath member relative thereto in a rotating direction.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an example of the arrangement of an attachment/detachment mechanism and operation tool system according to the first embodiment of the present invention;

FIG. 2 is an enlarged perspective view of the attachment/detachment mechanism and distal end portion of the operation tool system according to the first embodiment of the present invention;

FIG. 3 is a side sectional view showing an example of the arrangement of the attachment/detachment mechanism and operation tool system according to the first embodiment of the present invention;

FIG. 4 is a view showing an example of the arrangement of a means for exposing engaging members outside engaging member housing spaces and housing the members in the spaces;

FIG. 5 is a plan view viewed in the radial direction of the side circumferential surface of an outer sheath member in an attachment/detachment mechanism and operation tool system according to the first modification;

FIG. 6 is a side sectional view showing an example of the arrangement of an attachment/detachment mechanism and operation tool system according to the second modification;

FIG. 7 is a side sectional view showing an example of the arrangement of an attachment/detachment mechanism and operation tool system according to the second embodiment (before an operation tool is removed);

FIG. 8 is a side sectional view showing a change in the state of the attachment/detachment mechanism when an operation tool is removed;

FIG. 9 is a side sectional view showing an example of the arrangement of the attachment/detachment mechanism and operation tool system according to the second embodiment (when an operation tool is inserted into an outer sheath member);

FIG. 10 is a side sectional view showing an example of the arrangement of an attachment/detachment mechanism and operation tool system according to the third modification (before an operation tool is removed);

FIG. 11 is a side sectional view showing a change in the state of the attachment/detachment mechanism when an operation tool is removed;

FIG. 12 is a side sectional view showing an example of the arrangement of an attachment/detachment mechanism and operation tool system according to the fourth modification;

FIG. 13 is a sectional view of the attachment/detachment mechanism and operation tool system according to the fourth modification, taken along a line A-A in FIG. 12;

FIG. 14 is a view showing an example of how an outer sheath member engages with an operation tool when the operation tool moves inside the outer sheath member in the attachment/detachment mechanism and operation tool system according to the fourth modification;

FIG. 15 is a side sectional view showing an example of the arrangement of an attachment/detachment mechanism and operation tool system according to the fifth modification;

FIG. 16 is a sectional view of the attachment/detachment mechanism and operation tool system according to the fifth modification, taken along a line B-B in FIG. 15; and

FIG. 17 is a view showing an example of how an outer sheath member engages with an operation tool when the operation tool moves inside the outer sheath member in the attachment/detachment mechanism and operation tool system according to the fifth modification.

### DETAILED DESCRIPTION OF THE INVENTION

The embodiments of the present invention will be described below with reference to the views of the accompanying drawing.

### First Embodiment

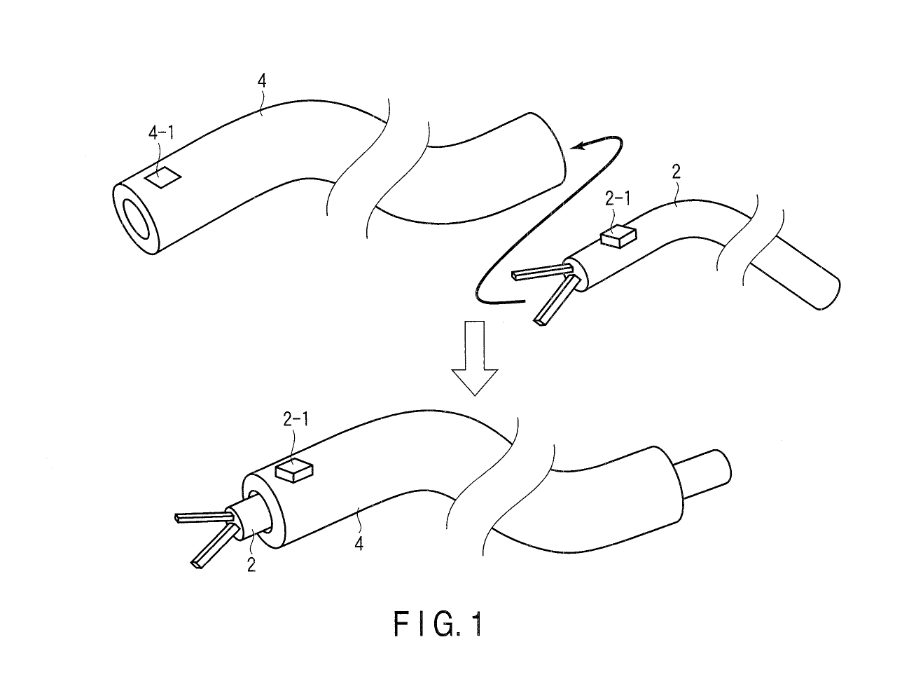

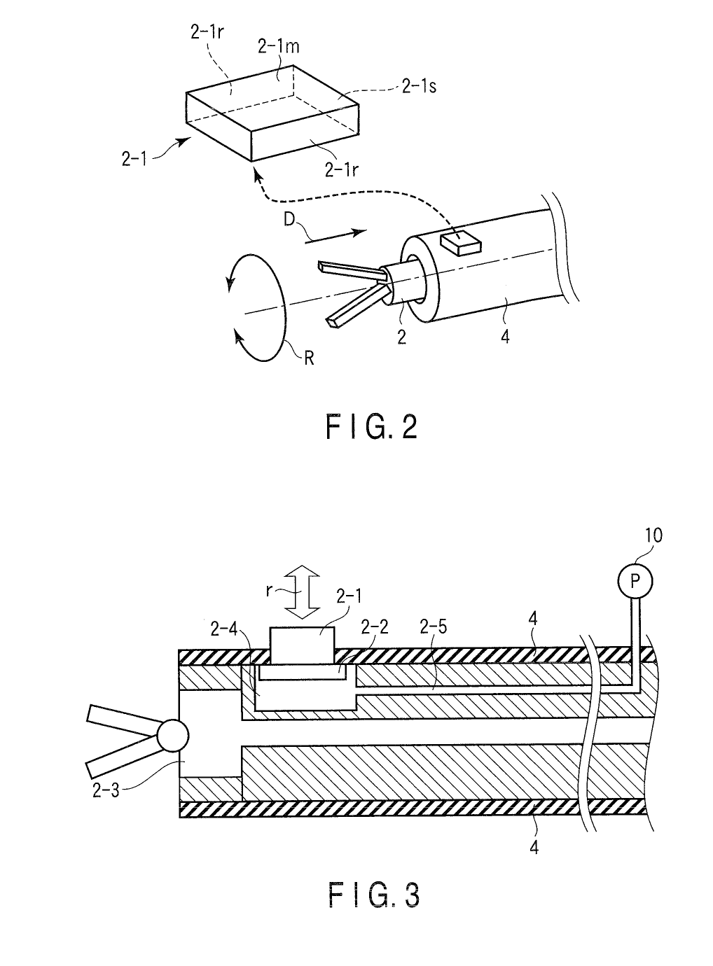

FIG. 1 is a perspective view showing an example of the arrangement of an attachment/detachment mechanism and operation tool system according to the first embodiment of the present invention. FIG. 2 is an enlarged perspective view of the attachment/detachment mechanism and distal end portion of the operation tool system according to the first embodiment. FIG. 3 is a side sectional view showing an example of the arrangement of the attachment/detachment mechanism and operation tool system according to the first embodiment.

The operation tool system according to the first embodiment includes an operation tool 2 and an outer sheath member 4.

The operation tool 2 is, for example, a long flexible member such as a manipulator, which includes an engaging member 2-1, a stopper 2-2, a driving means placement space 2-3, an engaging member housing space 2-4, and an air path 2-5.

The outer sheath member 4 is a long member having an almost cylindrical shape provided with a hole portion 4-1 in the side circumferential surface at a position near the distal end portion (the end portion on the operation field side). More specifically, the hole portion 4-1 is provided at a position where the engaging member 2-1 (to be described in detail later) of the operation tool 2 is located when the operator inserts the operation tool 2 into the outer sheath member 4 and actually performs operation using the operation tool 2. In addition, the hole portion 4-1 is formed to have almost the same dimensions and almost the same shape as those of the opening area of the engaging member housing space 2-4 (to be described in detail later) of the operation tool 2.

The engaging member 2-1 is a projection portion projecting in the radial direction, which is provided on the side circumferential surface of the operation tool 2 at a position near the distal end portion (the end portion on the operation field side). More specifically, the engaging member 2-1 has an almost rectangular parallelepiped shape and includes a removing-direction engaging surface 2-1s perpendicular to a removing direction D and a twisting-direction engaging surface 2-1r perpendicular to a twisting direction R.

The removing-direction engaging surface 2-1s engages with the hole portion 4-1 of the outer sheath member 4 to restrict the movement of the operation tool 2 in the removing direction D.

The twisting-direction engaging surface 2-1r engages with the hole portion 4-1 of the outer sheath member 4 to restrict the movement of the operation tool 2 in the twisting direction R.

The upper surface (principal plane 2-1m) of the engaging member 2-1 is formed to have almost the same dimensions (or slightly smaller dimensions) and almost the same shape as those of the hole portion 4-1 of the outer sheath member 4. In other words, the principal plane 2-1m of the engaging member 2-1 is formed to have almost the same dimensions (or slightly smaller dimensions) and almost the same shape as those of the opening area of the engaging member housing space 2-4 of the operation tool 2 (to be described later).

The stopper 2-2 is a plate-like member having a principal plane having a larger area than the opening area of the engaging member housing space 2-4 which is open to the outside, and is integrally formed with the bottom surface (the surface on the opposite side to the opening area) of the engaging member 2-1. This prevents the engaging member 2-1 from slipping out from the engaging member housing space 2-4.

The driving means placement space 2-3 is a space for placing a means (for example, a driving wire) for driving (for example, mechanically or electrically driving) each portion of the operation tool 2.

The engaging member housing space 2-4 is a space in which the engaging member 2-1 integrally formed with the stopper 2-2 is housed and to which the air path 2-5 is connected.

The air path 2-5 connects an air pressure adjustment means 10 to the engaging member housing space 2-4 to allow the air pressure adjustment means 10 to adjust the air pressure in the engaging member housing space 2-4.

The air pressure adjustment means 10 is a means for adjusting the air pressure in the engaging member housing space 2-4 via the air path 2-5 to expose the engaging member 2-1 outside the engaging member housing space 2-4 and house the engaging member 2-1 in it (to move the engaging member 2-1 in the radial direction indicated by an arrow r in FIG. 3).

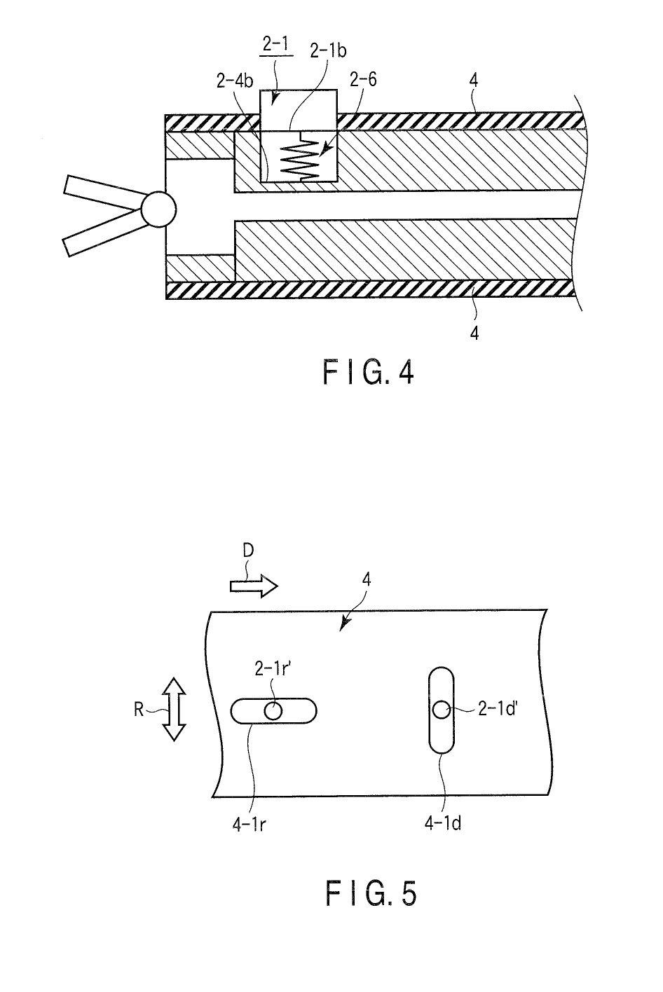

Note that the stopper 2-2, air path 2-5, and air pressure adjustment means 10 described above are not essential constituent elements. That is, it is possible to use a member having any arrangement as long as it can expose the engaging member 2-1 outside the engaging member housing space 2-4 and house the engaging member 2-1 in it. For example, as shown in FIG. 4, connecting a bottom surface 2-4b of the engaging member housing space 2-4 to a bottom surface 2-1b of the engaging member 2-1, which faces the bottom surface 2-4b, via an elastic member 2-6 such as a spring can expose the engaging member 2-1 outside the engaging member housing space 2-4 and house the engaging member 2-1 in it, as needed.

When inserting the operation tool 2 into the outer sheath member 4, the operator houses the engaging member 2-1 in the engaging member housing space 2-4. More specifically, in the arrangement example shown in FIG. 3, the operator makes the air pressure adjustment means 10 reduce the air pressure in the engaging member housing space 2-4, and houses the engaging member 2-1 in the engaging member housing space 2-4. In the arrangement example shown in FIG. 4, the operator pushes the engaging member 2-1 toward the engaging member housing space 2-4 to compress the elastic member 2-6, and houses the engaging member 2-1 in the engaging member housing space 2-4.

Upon inserting the operation tool 2 into the outer sheath member 4, the operator aligns the position of the hole portion 4-1 of the outer sheath member 4 with the position of the opening area of the engaging member housing space 2-4, and exposes the engaging member 2-1 of the operation tool 2 from the engaging member housing space 2-4.

More specifically, in the arrangement example shown in FIG. 3, the operator makes the air pressure adjustment means 10 increase the air pressure in the engaging member housing space 2-4, and exposes the engaging member 2-1 from the engaging member housing space 2-4 and the hole portion 4-1 of the outer sheath member 4. In the arrangement example shown in FIG. 4, releasing the pressing force of the engaging member 2-1 toward the engaging member housing space 2-4 will expose the engaging member 2-1 from the engaging member housing space 2-4 and the hole portion 4-1 of the outer sheath member 4 owing to the elastic force of the elastic member 2-6. With this arrangement, engaging the engaging member 2-1 with the hole portion 4-1 of the outer sheath member 4 will restrict the rotation of the operation tool 2 in the twisting direction R and the movement of the operation tool 2 in the removing direction D.

More specifically, when the removing-direction engaging surface 2-1s of the engaging member 2-1 engages with the hole portion 4-1, the relative positions of the operation tool 2 and outer sheath member 4 are fixed in the removing direction D. When the twisting-direction engaging surface 2-1r of the engaging member 2-1 engages with the hole portion 4-1, the relative positions of the operation tool 2 and outer sheath member 4 are fixed in the twisting direction R.

As described above, the first embodiment can provide an attachment/detachment mechanism for an insertion member and an outer sheath member, which can reliably fix them in the twisting direction (rotating direction) and the removing direction.

### [First Modification]

An attachment/detachment mechanism and operation tool system according a modification of the first embodiment will be described below. In order to avoid a redundant description, a difference from the attachment/detachment mechanism and operation tool system according to the first embodiment will be described. This difference resides in the arrangement of the engaging members of the operation tool and hole portions of the outer sheath member. FIG. 5 is a plan view when viewed in the radial direction of the side circumferential surface of the outer sheath member in the attachment/detachment mechanism and operation tool system according to the first modification.

In the first modification, the engaging members of the operation tool 2 include two members, namely a removing-direction engaging member 2-1d′ having an almost cylindrical shape which engages with the hole portion of the outer sheath member 4 to restrict the movement of the operation tool 2 in the removing direction D and a twisting-direction engaging member 2-1r′ having an almost cylindrical shape which engages with the hole portion of the outer sheath member 4 to restrict the movement of the operation tool 2 in the twisting direction R. That is, this modification includes different engaging members for the respective directions in which the movement of the operation tool 2 is restricted.

The outer sheath member 4 includes a removing-direction engaging hole 4-1d which has an elongated-hole shape (the length is determined by the allowable movement range of the operation tool 2 in the twisting direction R, and the width is almost equal to the diameter of the removing-direction engaging member 2-1d′), with the twisting direction R being the longitudinal direction, and engages with the removing-direction engaging member 2-1d′ of the operation tool 2 and a twisting-direction engaging hole portion 4-1r which has an elongated-hole shape (the length is determined by the allowable movement range of the operation tool 2 in the removing direction D, and the width is almost equal to the diameter of the twisting-direction engaging member 2-1r′), with the removing direction D being the longitudinal direction, and engages with the twisting-direction engaging member 2-1r′ of the operation tool 2.

In this case, the removing-direction engaging member 2-1d′ engages with the removing-direction engaging hole 4-1d, with the twisting direction R being the longitudinal direction, to restrict the movement of the operation tool 2 in the removing direction D. Likewise, the twisting-direction engaging member 2-1r′ engages with the twisting-direction engaging hole portion 4-1r having the elongated-hole shape, with the removing direction D being the longitudinal direction, to restrict the movement of the operation tool 2 in the twisting direction R.

The opening area of the engaging member housing space (not shown) for housing the removing-direction engaging member 2-1d′ is formed to have almost the same dimensions and almost the same shape as those of the removing-direction engaging hole 4-1d of the outer sheath member 4. Likewise, the opening area of the engaging member housing space (not shown) for housing the twisting-direction engaging member 2-1r′ is formed to have almost the same dimensions and almost the same shape as those of the twisting-direction engaging hole portion 4-1r of the outer sheath member 4.

Housing only the removing-direction engaging member 2-1d′ of the removing-direction engaging member 2-1d′ and the twisting-direction engaging member 2-1r′ in the engaging member housing space (not shown) allows the operation tool 2 to move in the outer sheath member 4 in the removing direction D within the length range in the longitudinal direction of the twisting-direction engaging hole portion 4-1r having the elongated-hole shape.

Likewise, housing only the twisting-direction engaging member 2-1r′ of the removing-direction engaging member 2-1d′ and the twisting-direction engaging member 2-1r′ in the engaging member housing space (not shown) allows the operation tool 2 to move in the outer sheath member 4 in the twisting direction R within the length range in the longitudinal direction of the removing-direction engaging hole 4-1d having the elongated-hole shape.

As described above, the second embodiment can provide an attachment/detachment mechanism and operation tool system which have the same effects as those of the attachment/detachment mechanism and operation tool system according to the first embodiment and allow the operation tool 2 to move within a predetermined range inside the outer sheath member 4.

### [Second Modification]

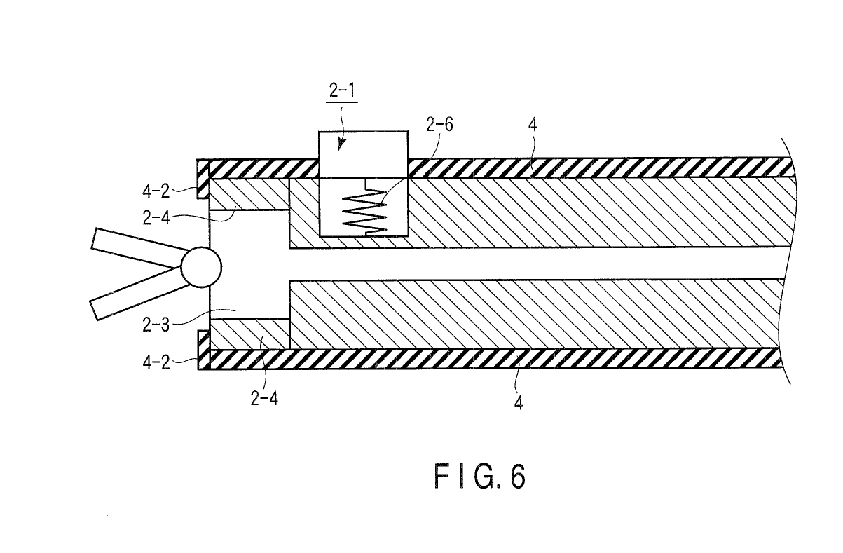

An attachment/detachment mechanism and operation tool system according to a modification of the first embodiment will be described below. In order to avoid a redundant description, a difference from the attachment/detachment mechanism and operation tool system according to the first embodiment will be described. This difference resides in the structure of the distal end portion (the end portion on the operation field side; ditto for the following). FIG. 6 is a side sectional view showing an example of the arrangement of an attachment/detachment mechanism and operation tool system according to the second modification of the first embodiment.

In the second modification, an abutment surface 4-2 for preventing the operation tool 2 from being exposed and slipping off from the distal end portion of the outer sheath member 4 is provided on the distal end portion of the outer sheath member 4. More specifically, the abutment surface 4-2 is a member having an almost annular shape, and is configured such that a tool mounted on the distal end of the operation tool 2 is exposed from the hollow portion.

As described above, the second modification can provide an attachment/detachment mechanism and operation tool system which have the same effects as those of the attachment/detachment mechanism and operation tool system according to the first embodiment and enhance convenience.

### Second Embodiment

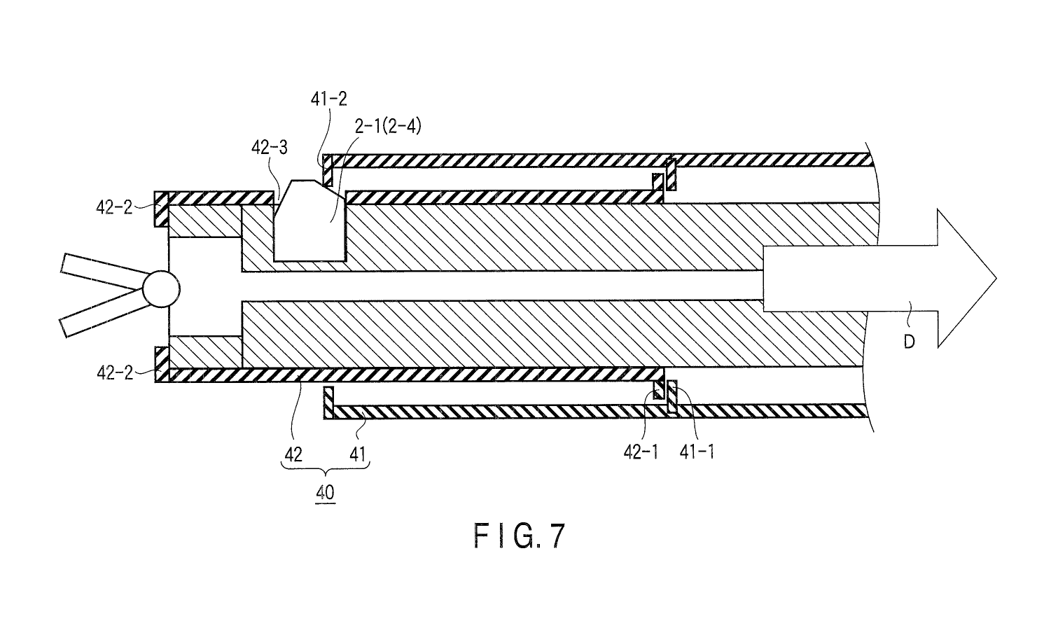

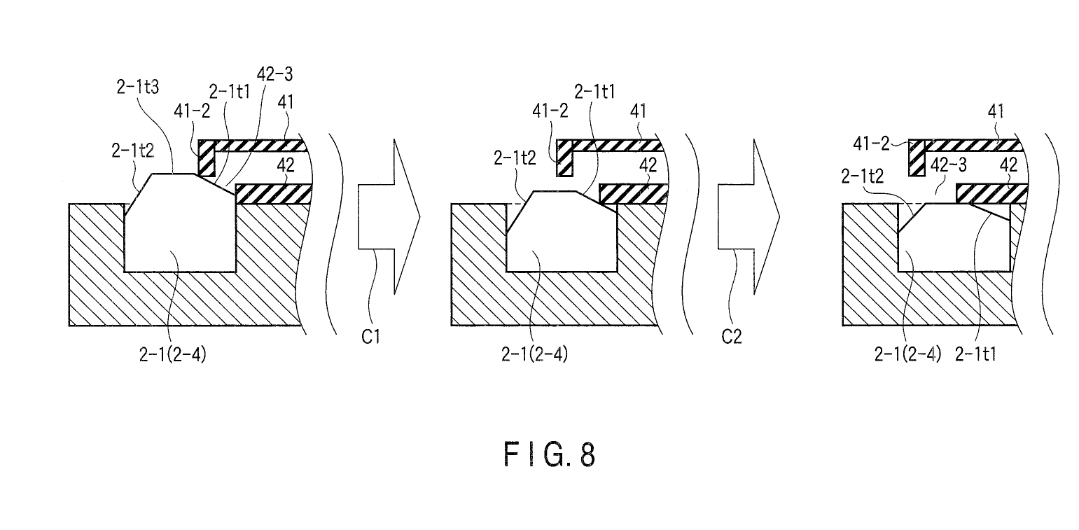

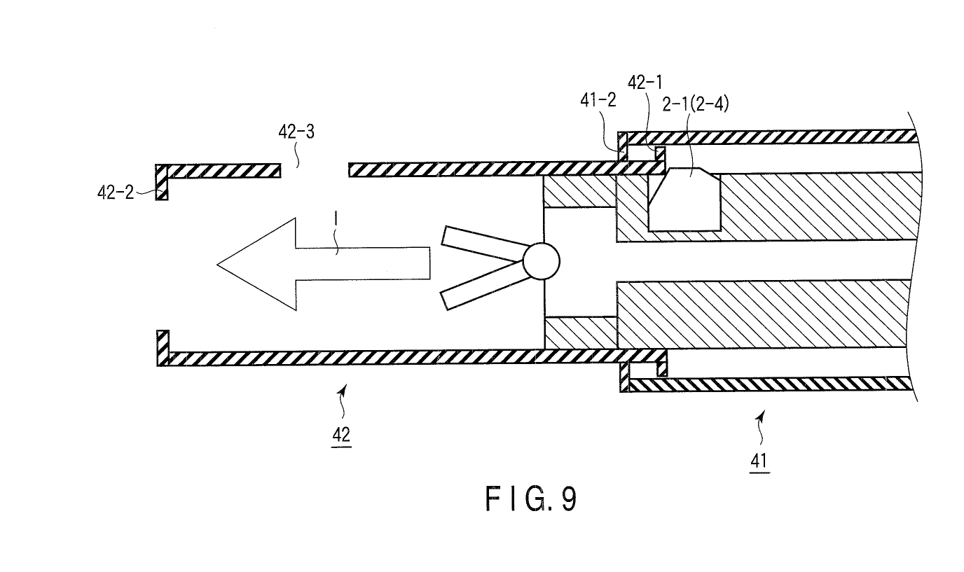

An attachment/detachment mechanism and operation tool system according to the second embodiment of the present invention will be described below. In order to avoid a redundant description, a difference from the attachment/detachment mechanism and operation tool system according to the first embodiment will be described. FIG. 7 is a side sectional view showing an example of the arrangement of the attachment/detachment mechanism and operation tool system according to the second embodiment (before the operation tool is removed). FIG. 8 is a side sectional view showing a change in the state of the attachment/detachment mechanism when an operation tool is removed. FIG. 9 is a side sectional view showing an example of the arrangement of the attachment/detachment mechanism and operation tool system according to the second embodiment (when the operation tool is inserted into the outer sheath member).

In the operation tool system according to the second embodiment, an outer sheath member 40 includes a first outer sheath member 41 and a second outer sheath member 42.

The first outer sheath member 41 is an outer sheath member having an almost cylindrical shape which houses the second outer sheath member 42 so as to allow it to move along the longitudinal direction. The first outer sheath member 41 includes a locking portion 41-1 as a projection member (or a member having an almost annular shape) projecting in the radial direction, which engages with the rear end portion (the end portion on the removing direction D side) of the second outer sheath member 42, when an operation tool 2 is removed, to restrict the movement of the second outer sheath member 42 in the removing direction D, and a removal engaging portion 41-2 which engages with an engaging member 2-1, when the operation tool 2 is removed, to push the engaging member 2-1 into an engaging member housing space 2-4 (in the radial direction of the operation tool 2).

The second outer sheath member 42 is an outer sheath member having an almost cylindrical shape with a smaller diameter than the first outer sheath member 41, and is configured to be movable in the first outer sheath member 41 along the longitudinal direction. The second outer sheath member 42 includes a convex portion 42-1 which abuts against the locking portion 41-1 of the first outer sheath member 41 when the operation tool 2 is removed, an abutment surface 42-2 for preventing the operation tool 2 from being exposed and slipping off from the distal end portion of the second outer sheath member 42, and a hole portion 42-3 provided in a portion at which the engaging member 2-1 of the operation tool 2 is located when the operator inserts the operation tool 2 into the second outer sheath member 42 and actually performs operation.

In the second embodiment, the engaging member 2-1 of the operation tool 2 is made of a material which deforms under a compression load, and is formed to have a size that causes part of the upper surface side (the outer side in the radial direction of the operation tool 2) of the engaging member 2-1 to be exposed from the engaging member housing space 2-4. The upper surface of the engaging member 2-1 includes a first tapered surface 2-1t1, a second tapered surface 2-1t2, and an upper surface 2-1t3 (see FIG. 8).

A material for the engaging member 2-1 includes, for example, rubber, a resin (for example, plastic), a metal having elasticity (for example, a superelastic alloy such as a TiNi alloy), and a compressed fluid (for example, a compressed fluid sealed in the hollow portion of a resin member having a hollow shape).

The first tapered surface 2-1t1 is a cam surface having the following function when the operator removes the operation tool 2 (when the operator removes it in the removing direction indicated by an arrow D in FIG. 7). That is, when the operator removes the operation tool 2, the first tapered surface 2-1t1 engages with the removal engaging portion 41-2 of the first outer sheath member 41 as shown in FIG. 8. This engagement applies force to the engaging member 2-1 in a direction to compressively deform it. When the operator continues the removing operation, the engaging member 2-1 compressively deforms until the first tapered surface 2-1t1 engages with the edge of the hole portion 42-3 of the second outer sheath member 42 (see the change in state indicated by an arrow C1 in FIG. 8).

Due to the state change C1, the first tapered surface 2-1t1 engages with the edge of the hole portion 42-3 of the second outer sheath member 42 as shown in FIG. 8, and the engaging member 2-1 further compressively deforms. When the operator continues the removing operation, the engaging member 2-1 compressively deforms until it is housed in the engaging member housing space 2-4 (the state change indicated by an arrow C2 in FIG. 8). The upper surface 2-1t3 of the engaging member 2-1 is pressed against the inner circumferential surface of the second outer sheath member 42 owing to the restoring force that causes the engaging member 2-1 to return to the normal state while the engaging member 2-1 is housed in the engaging member housing space 2-4.

When the operator removes the operation tool 2, the second outer sheath member 42 moves in the removing direction D together with the operation tool 2 due to the frictional force between the second outer sheath member 42 and the operation tool 2, and the convex portion 42-1 engages with (abuts against) the locking portion 41-1 of the first outer sheath member. When the operator continues the removing operation in this state, the state change C1 and the state change C2 described above occur (see FIG. 8).

The second tapered surface 2-1t2 has the following function when the operator inserts the operation tool 2 into the second outer sheath member 42. That is, when the operator inserts the operation tool 2 into the second outer sheath member 42 by moving the operation tool 2 in the direction indicated by an arrow I in FIG. 9, the second tapered surface 2-1t2 engages with the rear end portion of the second outer sheath member 42. This engagement applies force that causes the engaging member 2-1 to compressively deform inward in the radial direction. When the operator continues this inserting operation, the engaging member 2-1 is housed in the engaging member housing space 2-4. At this time, the upper surface 2-1t3 of the engaging member 2-1 is pressed against the second outer sheath member 42 owing to the restoring force that causes the engaging member 2-1 to return to the normal state.

As described above, the second embodiment can provide an attachment/detachment mechanism and operation tool system according to the first embodiment which have the same effects as those of the attachment/detachment mechanism and operation tool system according to the first embodiment, and allow the operation tool 2 as an insertion member to be easily removed.

### [Third Modification]

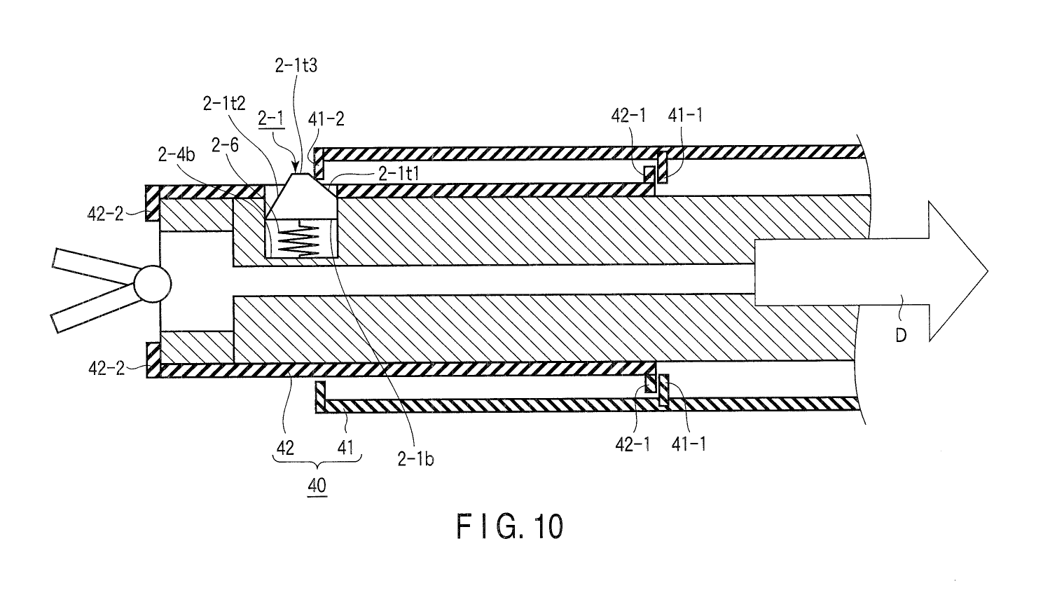

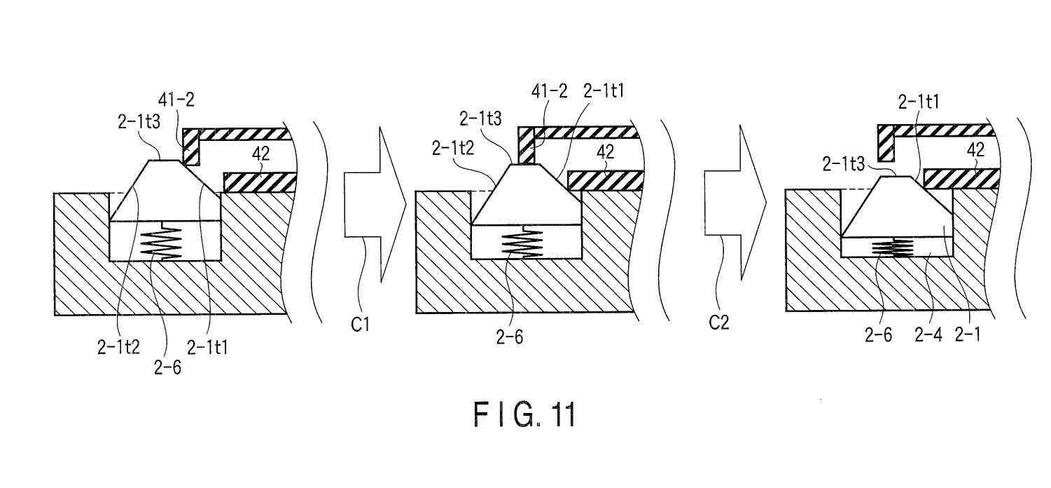

An attachment/detachment mechanism and operation tool system according to a modification of the second embodiment will be described below. In order to avoid a redundant description, a difference from the attachment/detachment mechanism and operation tool system according to the second embodiment will be described. This difference resides in the arrangement of the engaging member 2-1. FIG. 10 is a side sectional view showing an example of the arrangement of an attachment/detachment mechanism and operation tool system according to the third modification (before the operation tool is removed). FIG. 11 is a side sectional view showing a change in the state of the attachment/detachment mechanism when the operation tool is removed.

In the second embodiment, the engaging member 2-1 is a member which has a size that causes part of the engaging member 2-1 to be exposed from the engaging member housing space 2-4 and is made of a compressively deformable material. However, the engaging member 2-1 is not limited to the above form as long as the member is partly exposed from the engaging member housing space 2-4 and can be housed in the engaging member housing space 2-4 upon application of a pressure to the engaging member 2-1.

In the third modification, the engaging member 2-1 is a member made of a material which cannot compressively deform, and is formed to be smaller than the engaging member housing space 2-4. An elastic member 2-6 (for example, a spring) connects a surface 2-1b, of the engaging member 2-1, which faces a bottom surface 2-4b of the engaging member housing space 2-4, to the bottom surface 2-4b of the engaging member housing space 2-4. As in the second embodiment, this arrangement properly allows the engaging member 2-1 to be exposed outside the engaging member housing space 2-4 and be housed in it (see FIG. 11).

As described above, the third modification can provide an attachment/detachment mechanism and operation tool system which have the same effects as those of the attachment/detachment mechanism and operation tool system according to the second embodiment.

The present invention has been described above based on the first and second embodiments. Obviously, however, the present invention is not limited to the embodiments and modifications described above, and can be variously modified and applied within the spirit and scope of the invention.

### [Fourth Modification]

An attachment/detachment mechanism and operation tool system according to the fourth modification will be described below. The fourth modification can be applied to each embodiment and each modification described above. However, for the sake of descriptive convenience, the following description will be made on the assumption that the fourth modification is applied to the first embodiment. In order to avoid a redundant description, a difference from the attachment/detachment mechanism and operation tool system according to the first embodiment will be described.

Each embodiment and each modification described above are configured to allow the engaging member 2-1 of the operation tool 2 to be exposed outside the engaging member housing space 2-4 and housed in it. However, each embodiment and each modification may be configured not to allow the engaging member 2-1 of the operation tool 2 to be housed in the engaging member housing space 2-4. In other words, the engaging member 2-1 of the operation tool 2 may be fixed in a convex state in the radial direction of the operation tool 2.

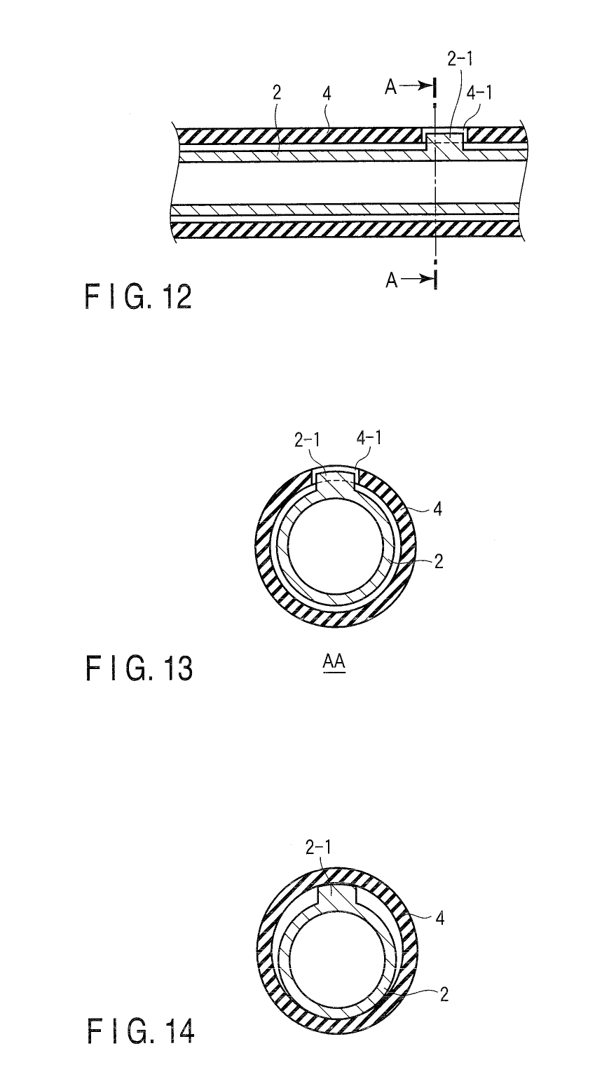

FIG. 12 is a side sectional view showing an example of the arrangement of an attachment/detachment mechanism and operation tool system according to the fourth modification. FIG. 13 is a sectional view of the attachment/detachment mechanism and operation tool system according to the fourth modification, taken along a line A-A iii FIG. 12. FIG. 14 is a view showing an example of how the outer sheath member 4 engages with the operation tool 2 when the operation tool 2 moves inside the outer sheath member 4 in the attachment/detachment mechanism and operation tool system according to the fourth modification.

FIGS. 12 and 13 show a state in which the engaging member 2-1 of the operation tool 2 is inserted into the hole portion 4-1 of the outer sheath member 4. While the operation tool 2 is inserted into the outer sheath member 4 and reaches the state shown in FIGS. 12 and 13, the engaging member 2-1 of the operation tool 2 inwardly presses the outer sheath member 4 to slightly spread it in the radial direction, as shown in FIG. 14. Even if the engaging member 2-1 is fixed in a convex state in the radial direction of the operation tool 2 in this manner, it is possible to insert the operation tool 2 into the outer sheath member 4.

As described above, applying the fourth modification to each embodiment and each modification can further simplify the structure as well as having the same effects as those of each embodiment and each modification.

### [Fifth Modification]

An attachment/detachment mechanism and operation tool system according to the fifth modification will be described below. The fifth modification can be applied to each embodiment and each modification described above. However, for the sake of descriptive convenience, the following description will be made on the assumption that the fifth modification is applied to the first embodiment. In order to avoid a redundant description, a difference from the attachment/detachment mechanism and operation tool system according to the first embodiment will be described.

In each embodiment and each modification described above, the engaging member (engaging member 2-1) of the attachment/detachment mechanism is provided on the operation tool 2 as an insertion member, and the hole portion (hole portion 4-1) of the attachment/detachment mechanism is provided in the outer sheath member 4. However, it is possible to provide the engaging member on the outer sheath member 4 and the hole portion in the operation tool (insertion member) 2.

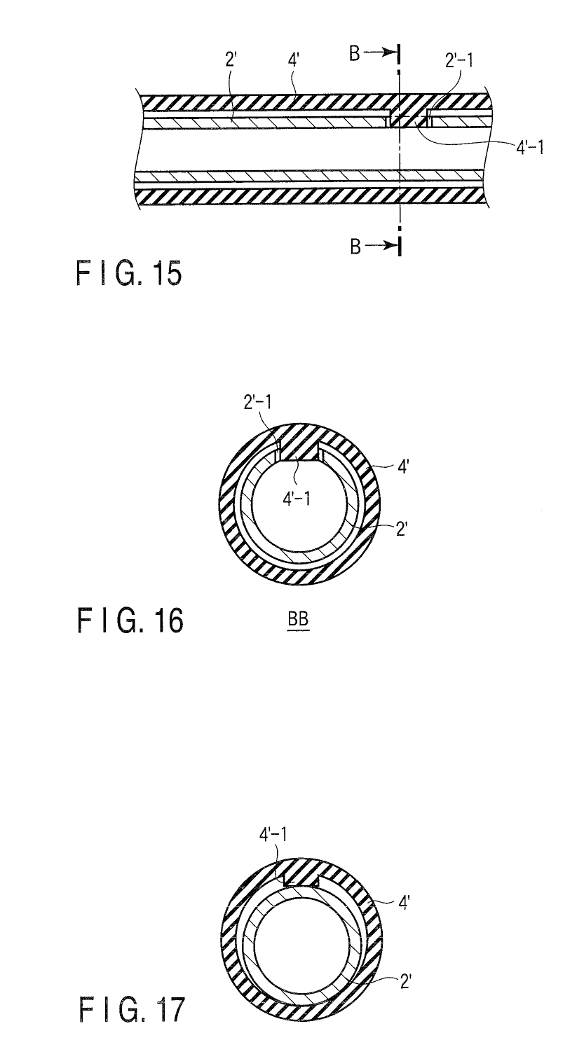

FIG. 15 is a side sectional view showing an example of the arrangement of the attachment/detachment mechanism and operation tool system according to the fifth modification. FIG. 16 is a sectional view of the attachment/detachment mechanism and operation tool system according to the fifth modification, taken along a line B-B in FIG. 15. FIG. 17 is a view showing an example of how the outer sheath member 4 engages with the operation tool 2 when the operation tool 2 moves inside the outer sheath member 4 in the attachment/detachment mechanism and operation tool system according to the fifth modification.

FIGS. 15 and 16 show a state in which an engaging member 4′-1 of an outer sheath member 4′ is inserted in a hole portion 2′-1 of an operation tool 2′. While the operation tool 2 is inserted into the outer sheath member 4 and reaches the state shown in FIGS. 15 and 16, the engaging member 2 inwardly presses the outer sheath member 4 to slightly spread it in the radial direction, as shown in FIG. 17. Even if an engaging member is provided on the outer sheath member 4 and a hole portion is provided in the operation tool (insertion member) 2, it is possible to insert the operation tool 2 into the outer sheath member 4.

As described above, applying the fifth modification to each embodiment and each modification can form an attachment/detachment mechanism and operation tool system which have the same effects as those of each embodiment and each modification.

In addition, the above embodiments include inventions of various stages, and various inventions can be extracted by proper combinations of a plurality of disclosed constituent elements. When, for example, the above problems can be solved and the above effects can be obtained even if several constituent elements are omitted from all the constituent elements in each embodiment, the arrangement from which these constituent elements are omitted can be extracted as an invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An attachment/detachment mechanism which detachably fixes an insertion member inserted in an outer sheath member thereto, the mechanism comprising:
a removal preventing member configured to restrict movement of the insertion member in the outer sheath member relative thereto in a removing direction; and
a rotation preventing member configured to restrict movement of the insertion member in the outer sheath member relative thereto in a rotating direction.

2. The mechanism according to claim 1, wherein the removal preventing member comprises a removal preventing engaging member and a removal preventing to-be-engaged portion,
the rotation preventing member comprises a rotation preventing engaging portion and a rotation preventing to-be-engaged portion,
one of the removal preventing engaging portion and the removal preventing to-be-engaged portion is provided for one of the insertion member and the outer sheath member, and one of the rotation preventing engaging portion and the rotation preventing to-be-engaged portion is provided for one of the insertion member and the outer sheath member, and
the other of the removal preventing engaging portion and the removal preventing to-be-engaged portion which is not provided for the one member is provided for the other of the insertion member and the outer sheath member, and the other of the rotation preventing engaging portion and the rotation preventing to-be-engaged portion which is not provided for the one member is provided for the other of the insertion member and the outer sheath member.

3. The mechanism according to claim 1, wherein the removal preventing member and the rotation preventing member comprise a common projection member having a substantially rectangular parallelepiped shape provided on the insertion member, and a hole portion which is provided in the outer sheath member and in which the projection member is inserted,
the removal preventing member comprises a surface of the projection member which is perpendicular to the removing direction, and
the rotation preventing member comprises a surface of the projection member which is perpendicular to the rotating direction.

4. The mechanism according to claim 3, wherein the outer sheath member has a substantially cylindrical shape,
and which further comprising an adjustment member configured to move the projection member in a radial direction of the outer sheath member,
wherein the projection member restricts movement in the removing direction and movement in the rotating direction, when located at a position at which the projection member overlaps the insertion member and the outer sheath member in the radial direction.

5. The mechanism according to claim 4, wherein the adjustment member comprises one of an air pressure adjustment member and an elastic member which move the projection member in a radial direction of the outer sheath member.

6. The mechanism according to claim 1, wherein the removal preventing member comprises a first elongated-hole portion with the rotating direction being a longitudinal direction, and is provided in the outer sheath member, and a first projection member which is provided on the insertion member and allows the insertion member to move only in the rotating direction upon insertion into the first hole portion, and
the rotation preventing member comprises a second hole portion which has an elongated-hole shape, with the removing direction being a longitudinal direction, and is provided in the outer sheath member, and a second projection member which is provided on the insertion member and allows the insertion member to move only in the removing direction upon insertion into the second hole portion.

7. The mechanism according to claim 1, wherein an abutment surface having a substantially annular shape is provided on an end portion of the outer sheath member in an inserting direction of the insertion member.

8. An operation tool system comprising an operation tool as an insertion member, and an outer sheath member in which the operation tool is inserted, the system comprising:
a removal preventing member configured to restrict movement of the operation tool inserted in the outer sheath member relative thereto in a removing direction; and
a rotation preventing member configured to restrict movement of the insertion member inserted in the outer sheath member relative thereto in a rotating direction.

9. The system according to claim 8, wherein the removal preventing member and the rotation preventing member comprise a common projection member having a substantially rectangular parallelepiped shape provided on the insertion member, and a hole portion which is provided in the outer sheath member and in which the projection member is inserted,
the removal preventing member comprises a surface of the projection member which is perpendicular to the removing direction, and
the rotation preventing member comprises a surface of the projection member which is perpendicular to the rotating direction.

10. The system according to claim 9, wherein the outer sheath member has a substantially cylindrical shape,
and which further comprising an adjustment member configured to move the projection member in a radial direction of the outer sheath member,
wherein the adjustment member restricts movement in the removing direction and movement in the rotating direction, when the projection member is located at a position at which the projection member overlaps the insertion member and the outer sheath member in the radial direction.

11. The system according to claim 8, wherein the removal preventing member comprises a first elongated-hole portion with the rotating direction being a longitudinal direction, and is provided in the outer sheath member, and a first projection member which is provided on the insertion member and allows the insertion member to move only in the rotating direction upon insertion into the first elongated-hole portion, and
the rotation preventing member comprises a second elongated-hole portion with the removing direction being a longitudinal direction, and is provided in the outer sheath member, and a second projection member which is provided on the insertion member and allows the insertion member to move only in the removing direction upon insertion into the second elongated-hole portion.

12. The system according to claim 9, wherein the outer sheath member includes a first outer sheath member and a second outer sheath member configured to move along a longitudinal direction upon being inserted into the first outer sheath member,
the operation tool is inserted into the second outer sheath member,
the first outer sheath member comprises a locking portion configured to restrict movement of the second outer sheath member in a removing direction upon engaging with an end portion of the second outer sheath in a removing direction when the operation tool is removed, and an engaging portion configured to push the projection member into the operation tool in a radial direction upon engaging with the projection member of the operation tool when the operation tool is removed, and
the second outer sheath member comprises an abutment surface which is provided on an end portion of the operation tool in an inserting direction and restricts movement of the operation tool in the inserting direction, and a convex portion which is provided on an end portion of the operation tool in a removing direction and engages with the locking portion when the operation tool is removed.

13. The system according to claim 12, wherein the first outer sheath member and the second outer sheath member have substantially cylindrical shapes,
and which further comprising an adjustment member configured to move or deform the projection member in a radial direction of the first outer sheath member and the second outer sheath member,
wherein the projection member restricts movement in the removing direction and movement in the rotating direction, when located at a position at which the projection member overlaps the insertion member and the second outer sheath member in the radial direction,
and a surface of the projection member which is located on an outer side in the radial direction is provided with a tapered surface formed toward the inserting direction and the removing direction.
